(19) United States
(12) Patent Application Publication
(10) Pub. No.: US 2026/0224424 A1
(43) Pub. Date: Aug. 6, 2026

(54) KNEE MUSCULAR STRENGTH-ASSISTING SUIT AND KNEE MUSCULAR STRENGTH-ASSISTING METHOD

(71) Applicant: KOREA INSTITUTE OF MACHINERY & MATERIALS, Daejeon (KR)

(72) Inventors: Cheol-hoon PARK, Daejeon (KR); Jun Uk CHU, Daegu (KR); Seyoung KIM, Daejeon (KR); Sung-Hyuk SONG, Daejeon (KR); Jeongae BAK, Daejeon (KR); Hyunuk SEO, Seoul (KR); Byoung-Kil HAN, Daejeon (KR); Jongwoo PARK, Sejong (KR); Hyun Mok JUNG, Daejeon (KR); Jeongdo AHN, Daejeon (KR); Younghun LEE, Daejeon (KR); Seongjun PARK, Daejeon (KR); Kyungjun CHOI, Daejeon (KR)

(21) Appl. No.: 19/154,887

(22) PCT Filed: May 27, 2024
(86) PCT No.: PCT/KR2024/007153

§ 371 Date: Aug. 8, 2025

(30) Foreign Application Priority Data
May 25, 2023 (KR) 10-2023-0067929
Aug. 4, 2023 (KR) 10-2023-0101940

(51) Int. Cl. A61H 1/02

(52) U.S. Cl. CPC A61H 1/024; A61H 2201/14; A61H 2201/165; A61H 2201/1657; A61H 2201/169

(57) ABSTRACT

An embodiment of the present disclosure discloses a knee muscular strength-assisting suit including a driving part arranged to generate a first driving force for knee muscular strength assistance, and a wearable part detachably coupled to the driving part and configured to transfer the first driving force to a wearer's knee and generate a second driving force capable of being transferred to the wearer's knee when used.

### TECHNICAL FIELD

Embodiments of the present disclosure relate to a muscular strength-assisting suit and a muscular strength-assisting method, and more particularly, to a knee muscular strength-assisting suit and a knee muscular strength-assisting method.

### BACKGROUND ART

In general, workers in industrial sites, stevedores, delivery workers, etc. often perform a repetitive heavy object-lifting and moving action.

Such work has the inconvenience of requiring the manpower of multiple people or requiring the use of auxiliary equipment, such as heavy equipment, cranes, or pulleys, depending on an on-site situation. Furthermore, in case that people work directly, there are problems such as increased worker fatigue and decreased work efficiency due to high work intensity and industrial accidents such as musculoskeletal damage and avoidance of related occupations, and in case that auxiliary equipment is used, there is a problem that the scope of use is limited because a relatively wide movement space or installation space is required.

These problems have led to an increased need for wearable muscular strength-assisting devices to alleviate a repetitive load-lifting and standing action or a heavy load-bearing action, and in particular, many wearable robots for knee muscular strength assistance for industrial workers and the disabled are being developed.

Existing knee muscular strength-assisting wearable robots are being developed by using motors or pneumatic actuators, but are difficult to wear and are uncomfortable to wear due to heavy weights and large volumes of the robots themselves. Furthermore, in case of passive devices, there is a limitation to an assistance effect because the passive devices do not provide active muscular strength assistance, and in particular, there is a problem that the passive devices are not easy to distribute because the passive devices are expensive.

To overcome this, research has been conducted on a wearable knee muscular strength-assisting robot that is lightweight, easy to wear, comfortable to wear, and may be worn for long periods of time in daily life, making it easily available to the public.

Moreover, there is a need to develop a wearable knee muscular strength-assisting robot that is small in volume and light in weight and may be conveniently carried and stored by a user even in case that muscular strength assistance is not necessary.

### DISCLOSURE OF INVENTION

### Technical Problem

Embodiments of the present disclosure may provide an improved knee muscular strength-assisting suit, for example, a knee muscular strength-assisting suit which improves the convenience of putting on and taking off and, when a driving force is applied, effectively transfers the driving force.

The technical problems to be achieved by the knee muscular strength-assisting suit according to the technical concept of the technology disclosed in the present specification are not limited to those described above, and other problems not disclosed herein will be clearly understood from the following description by those of ordinary skill in the art.

### Solution to Problem

An embodiment of the present disclosure discloses a knee muscular strength-assisting suit including a driving part arranged to generate a first driving force for knee muscular strength assistance, and a wearable part detachably coupled to the driving part and configured to transfer the first driving force to a wearer's knee and generate a second driving force capable of being transferred to the wearer's knee when used.

In the present embodiment, the first driving force may be an active driving force, and the second driving force may be a passive driving force.

In the present embodiment, the driving part may include a cloth muscle configured to contract or relax by power supplied from an outside.

In the present embodiment, the cloth muscle may include a woven fabric of warp and weft.

In the present embodiment, the woven fabric may include a spring-shaped thermal response driving element corresponding to one of the warp and the weft, and a heat-resistant wire configured to function as one of the warp and the weft.

In the present embodiment, the wearable part may include a driving part fixture configured to be coupled to the driving part, and a fastener installed at opposite ends of the wearable part in a longitudinal direction and configured to fix the knee muscular strength-assisting suit to the wearer.

In the present embodiment, the wearable part may include an elastic bar installed along the longitudinal direction of the wearable part and configured to generate the second driving force when used.

In the present embodiment, the driving part and the driving part fixture may be connected to each other by a zipper.

In the present embodiment, the fastener may include a thigh fastener and a calf fastener, and the fastener may be length-adjustable.

In the present embodiment, the elastic bar may not deform in the longitudinal direction so as to maintain a constant distance between the fasteners, and may be elastic in a bending direction of a knee joint so that the knee joint bends freely.

In the present embodiment, the wearable part may further include an amplifier configured to increase the first driving force.

Another embodiment of the present disclosure includes a passive muscular strength assistance operation by an elastic force of a wearable part which is capable of being transferred to a wearer's knee and an active muscular strength assistance operation by a driving force of a cloth muscle which is capable of being transferred to the wearer's knee, wherein before the cloth muscle is attached to the wearable part, only the passive muscular strength assistance may be performed, and after the cloth muscle is attached to the wearable part, the active muscular strength assistance may be performed together with the passive muscular strength assistance.

In the present embodiment, the elastic force of the wearable part may be generated by an elastic bar installed along a longitudinal direction of the wearable part.

In the present embodiment, the elastic bar may be configured to perform a passive muscular strength-assisting function and a position fixing function of a thigh-calf fastener for maintaining a contractile motion of the cloth muscle.

In the present embodiment, a driving force amplification operation configured to increase the driving force of the cloth muscle may be further included.

Another embodiment of the present disclosure discloses a knee muscular strength-assisting suit formed to perform any one of the knee muscular strength-assisting methods.

Another embodiment of the present disclosure discloses a knee muscular strength-assisting suit including a driving part arranged to generate a driving force for knee muscular strength assistance, an upper fastening part detachably coupled to an upper end of the driving part and arranged to be worn on an upper end of a wearer's knee, and a lower fastening part detachably coupled to a lower end of the driving part through a force transfer band and arranged to be worn on a lower end of the wearer's knee, wherein the lower fastening part includes a structure which is detachable from and attachable to an amplification part formed to convert a force generated from the driving part into a large rotation force.

In the present embodiment, the amplification part may include a pocket part formed to be detachable from and attachable to the lower fastening part, and an insert of a flexible material formed to be inserted into the pocket part.

In the present embodiment, the insert may have substantially a same shape as the pocket part.

In the present embodiment, the pocket part may include a calf attachment surface corresponding to a surface attached to the lower fastening part, a force transfer band attachment surface corresponding to a surface to which the force transfer band is attached, and an insert insertion surface for embedding the insert, and the force transfer band attachment surface may correspond to an inclined surface of a patellar structure.

In the present embodiment, the lower fastening part and the calf attachment surface may be connected to each other with Velcro, and the force transfer band and the force transfer band attachment surface may be connected to each other with Velcro over the entire inclined surface.

In the present embodiment, the insert to be inserted into the pocket part may be prepared to be selectable from a plurality of inserts, and the plurality of inserts may have different heights and/or different lengths of the calf attachment surface.

In the present embodiment, the surface of the insert corresponding to the calf attachment surface of the pocket part may be formed to be concave inward.

In the present embodiment, the driving part may include a cloth muscle configured to contract or relax by power supplied from an outside.

In the present embodiment, the cloth muscle may include a woven fabric of warp and weft.

In the present embodiment, an upper end of the driving part and the upper fastening part may be connected to each other by a zipper.

In the present embodiment, the force transfer band may be length-adjustable.

Another embodiment of the present disclosure discloses a knee muscular strength-assisting method using a patellar structure, including wearing an upper fastening part and a lower fastening part at an upper end and a lower end of a knee, respectively, and directly or indirectly coupling a cloth muscle formed to generate a driving force to the upper fastening part and the lower fastening part, respectively, and, in case that the driving force is to be converted into a large rotation force, using an amplification part by attaching the amplification part to the lower fastening part.

In the present embodiment, the amplification part may include a pocket part formed to be detachable from and attachable to the lower fastening part, and an insert of a flexible material formed to be inserted into the pocket part, wherein the insert inserted into the pocket part may be selected from a plurality of inserts having different heights and/or different lengths of a calf attachment surface.

The knee muscular strength-assisting suit according to another embodiment of the present disclosure is configured to perform the knee muscular strength-assisting method described above.

### Advantageous Effects of Invention

A knee muscular strength-assisting suit and a knee muscular strength-assisting method according to embodiments of the present disclosure may improve the convenience of putting on and taking off and, when a driving force is applied, may effectively transfer the driving force.

On the other hand, these effects described are merely illustrative, and effects predicted or expected from the detailed configuration of the present disclosure from the perspective of those of ordinary skill in the art may also be added to the unique effects of the present disclosure.

### BRIEF DESCRIPTION OF DRAWINGS

FIG. 1 illustrates a knee muscular strength-assisting suit according to an embodiment of the present disclosure.

FIG. 2 is an example configuration diagram of a cloth muscle, which is a driving part used in FIG. 1.

FIG. 3 is an exploded perspective view of FIG. 2.

FIG. 4 is actual and enlarged photographs of a cloth muscle according to an embodiment of the present disclosure.

FIG. 5 is a flowchart showing a method of manufacturing a shape memory alloy (SMA) spring fabric of FIG. 4.

FIG. 6 is an example diagram and a flowchart respectively showing an example of an apparatus for manufacturing SMA spring yarn and a method of manufacturing the same in FIG. 5.

FIG. 7 is an example configuration diagram of a wearable part used in FIG. 1.

FIG. 8 illustrates an action of an elastic bar in FIG. 7.

FIG. 9 conceptually illustrates active assistance and passive assistance as a knee muscular strength-assisting method according to an embodiment of the present disclosure.

FIG. 10 schematically illustrates a control-related concept of a knee muscular strength-assisting suit according to an embodiment of the present disclosure.

FIG. 11 illustrates a knee muscular strength-assisting suit according to another embodiment of the present disclosure.

FIG. 12 is an example configuration diagram of an upper fastening part of FIG. 11.

FIG. 13 is an example configuration diagram of a lower fastening part of FIG. 11.

FIG. 14 is an example configuration diagram of an amplification part of FIG. 11.

FIG. 15 is an example configuration diagram of an insert of FIG. 14.

FIG. 16 illustrates (a) an unused state and (b) a used state of the amplification part as a knee muscular strength-assisting method using the knee muscular strength-assisting suit of FIG. 11.

FIG. 17 schematically illustrates a control-related concept of the knee muscular strength-assisting suit of FIG. 11.

### MODE FOR THE INVENTION

Hereinafter, embodiments disclosed in the present specification are described in detail with reference to the accompanying drawings. Regardless of the reference symbols, the same or similar elements are denoted by the same reference numerals, and redundant descriptions thereof are omitted herein. The suffixes “module” and “part” for elements used in the following description are assigned or mixed in consideration of easiness in writing the specification and do not have distinctive meanings or roles by themselves. Furthermore, in describing embodiments disclosed in the present specification, when the detailed description of the relevant known technology is determined to unnecessarily obscure the gist of the embodiments disclosed in the present specification, the detailed description thereof is omitted herein. Moreover, the accompanying drawings are only used to help easily understanding embodiments disclosed in the present specification, and the technical concept disclosed in the present specification is not limited by the accompanying drawings. It will be understood that the present disclosure includes all modifications, equivalents, and substitutes falling within the concept and technical scope of the present disclosure.

It will be understood that although the terms “first,” “second” etc. may be used herein to describe various elements, these elements should not be limited by these terms.

These terms are only used to distinguish one element from another.

It will be understood that when an element is “connected” or “coupled” to another element,
the element may be directly connected or coupled to the other element or may be connected” or coupled to the other element with an intervening element therebetween. On the other hand, it will be understood when an element is “directly connected” or “directly coupled” to another element, no intervening element is present therebetween.

All terms including technical or scientific terms as used herein have the same meaning as commonly understood by those of ordinary skill in the art.

The terms “comprise,” “include,” or “have” as used in the present application are inclusive and therefore specify the presence of one or more stated features, integers, steps, operations, elements, components, or any combination thereof, but do not preclude the presence or addition of one or more other features, integers, steps, operations, elements, components, or any combination thereof.

Although the present disclosure has been illustrated and described in detail in the drawings and the foregoing description,
the present disclosure is to be considered illustrative in nature and not restrictive. Only certain embodiments have been illustrated and described, and it will be understood that all changes and modifications falling within the spirit of the present disclosure are preferably protected.

### Knee Muscular Strength-Assisting Suit

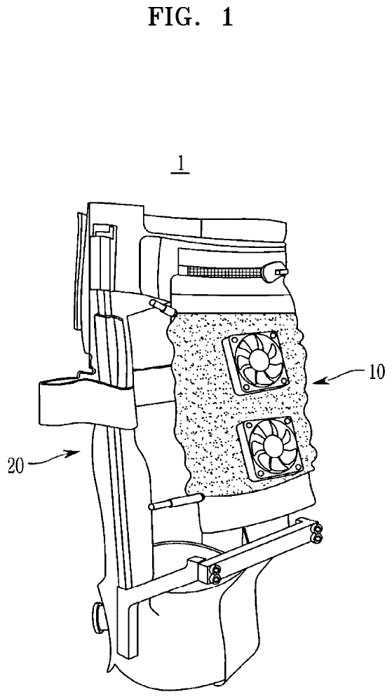

FIG. 1 illustrates a knee muscular strength-assisting suit 1 according to an embodiment of the present disclosure.

The knee muscular strength-assisting suit 1 may largely include a driving part 10 for knee muscular strength assistance, and a wearable part 20 which is detachably coupled to the driving part 10 so that a generated driving force may be transferred to a wearer's knee.

On the other hand, as an embodiment, the driving part 10 may generate an active driving force as a first driving force, and the wearable part 20 may generate a passive driving force as a second driving force. That is, the wearable part 20 in the present embodiment may not only function as a suit, but may also perform a function of generating a driving force for knee muscular strength assistance.

Hereinafter, each of the driving part 10 and the wearable part 20 is described in detail.

### Driving Part (Cloth Muscle)

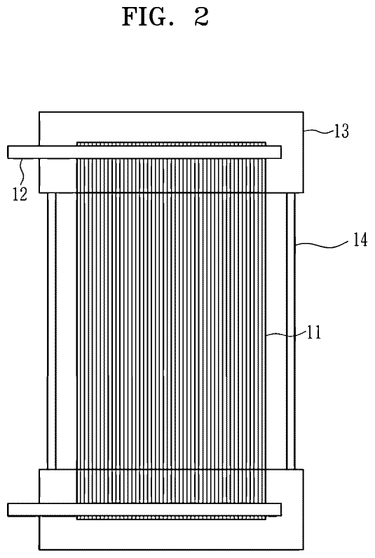

Hereinafter, a cloth muscle (or may be also referred to as a cloth-type flexible actuator), which is a driving part (an actuator) according to an embodiment of the present disclosure, is described in detail with reference to FIGS. 2 to 6 attached herein. For convenience of explanation, embodiments described in the present specification are described by taking, as an example, a case of a thermal response driving element which causes a cloth muscle to contract through Joule heating using an electric current.

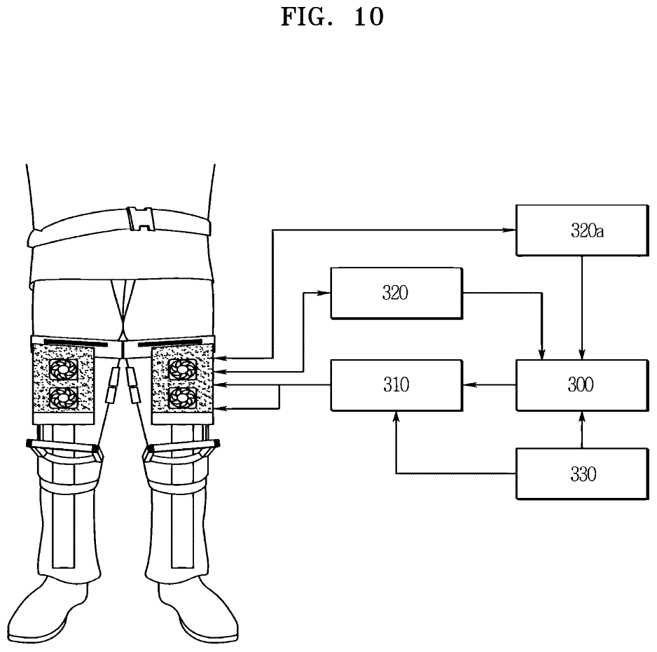

A cloth muscle 10 according to the present embodiment may be formed so that the cloth muscle itself contracts and relaxes by causing a control part (e.g., 300 of FIG. 10) to contract and relax a fabric-shaped thermal response driving element (11; hereinafter referred to as a “shape memory alloy (SMA) spring fabric”) in which a spring-shaped SMA is woven. Furthermore, the control part may be provided separately from the driving part, and in some cases, may be arranged adjacent to or integral with a region of the driving part or the wearable part.

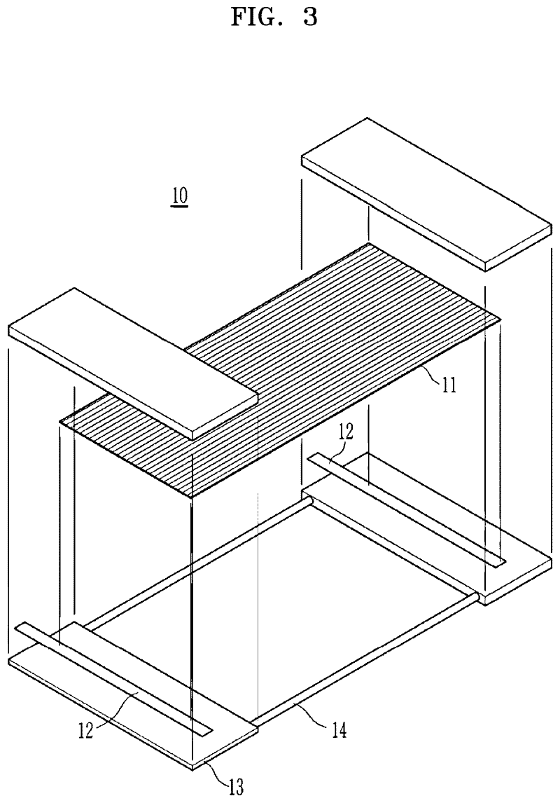

The cloth muscle 10 may include SMA spring fabrics 11 of various sizes or numbers depending on design needs, as illustrated in FIGS. 2 and 3, and various arrangements are possible accordingly.

The SMA is a material which may convert thermal energy into mechanical energy, such as a driving force or displacement. In this manner, a muscular strength-assisting function of the present embodiment may be easily implemented.

A shape memory alloy wire (hereinafter referred to as an SMA wire) may be implemented through various methods. For example, the SMA wire may be prepared to restore an original shape when stress is applied to a material in a low-temperature martensitic state to deform the material and then heat is applied so that the material becomes a high-temperature austenitic state.

In case that the SMA wire having a shrinkage displacement of only 2% to 5% is manufactured into a coil or spring shape, the shrinkage displacement of the SMA wire may be improved to 40% or more.

On the other hand, because an SMA spring 101 has a fast rate of contraction when heated but a slow rate of cooling, there is a limitation to improving a relaxation rate, which causes a problem that an overall driving speed slows down.

However, in the present embodiment, the diameter of the SMA wire used to manufacture the SMA spring 101 may be controlled to be thin so that a heating rate increases and a surface area to volume ratio increases, and thus, a cooling rate is also improved. For example, a cross-sectional area of an SMA wire having a micro-diameter of 0.08 mm is 1/39 of a cross-sectional area of an SMA wire having a thick diameter of 0.5 mm, which allows a surface area to unit volume ratio to increase by a factor of 6.25. Because a load capacity decreases as much as the cross-sectional area, theoretically 39 SMA springs manufactured by using the SMA wire having a diameter of 0.08 mm may be required to achieve the load capacity of one SMA spring manufactured by using the SMA wire having a diameter of 0.5 mm.

In case that a cloth muscle having a driving force of 10 kgf is manufactured by using the SMA spring including the SMA wire having a diameter of 0.5 mm, dozens (for example, 20) of SMA springs may be used, but in case that a user wears an actuator assembly including a plurality of such springs, the user will inevitably feel a sense of awkwardness and discomfort.

On the other hand, in order to have a driving force corresponding to 10 kgf of the cloth actuator manufactured by using the SMA spring including the SMA wire having a diameter of 0.5 mm, it may be necessary to use hundreds (for example, about 800) of SMA springs including the SMA wire having a diameter of 0.08 mm.

The present embodiment may be a solution to the need to develop a new type of cloth-type actuator using the SMA springs 101 including a large number of micro-diameter wires and a manufacturing process.

It should be noted that a case where the diameters of the wires constituting the SMA spring 101 are 0.5 mm and 0.08 mm has been described as an example, but the present disclosure is not necessarily applicable only to such diameters. As wires become thinner and the number of wires increases, new manufacturing methods and configurations which did not need to be previously considered are required. Therefore, wires having a diameter greater than 0.5 mm may also be sufficiently manufactured by using the new methods of the present disclosure. As described below, wires having any diameter which may be woven into a fabric form may be applicable to embodiments of the present disclosure.

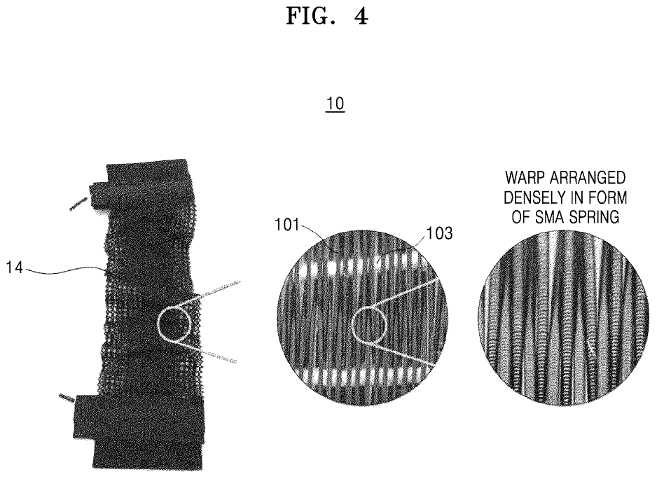

The present embodiment may include weaving a thermal response driving element into a single integrated fabric form like a fabric by using the fine SMA spring 101 as yarns of the fabric. An SMA spring fabric 11 according to the present embodiment may include warp (or weft) 101 and wire weft (or warp) 103 in the form of an SMA spring, as illustrated in FIG. 4.

A wire 103 corresponding to one of the warp and the weft may fix a plurality of SMA spring threads (wires) 101 within a plane, does not necessarily need to be formed densely, and may be formed at intervals that do not interfere with the contraction and relaxation motion of the SMA spring.

Furthermore, the wire 103 may be sufficiently made of a material which satisfies a condition that is not carbonized by a high-temperature heat treatment.

As illustrated in FIG. 4, a plurality of SMA springs 101 may be arranged adjacent to each other, and for example, may be flexible and woven in close contact with each other within a fabric.

By weaving the SMA springs 101 tightly like the warp or weft of fabric as described above, a large number of SMA springs 101 may be arranged at a uniform density per unit area.

In this manner, a large force may be generated due to the arrangement of a large number of SMA springs per area, and cooling performance may also be improved due to the uniform arrangement of SMA springs.

Moreover, the cloth muscle according to the present embodiment may be manufactured through the same process as a general weaving machine (textile machine), may be mass-produced through automation, and may be provided to the user in the fabric form. In case that the cloth muscle may be provided in the fabric form, the user may use the cloth muscle by directly cutting the cloth muscle into a desired shape, size, etc. Accordingly, the freedom of design may also be improved.

For example, hundreds of SMA springs may be assembled to form the SMA spring fabric 11, which is a single module. By using the fabric based on the micro-diameter SMA wire, the flexibility of the cloth is significantly maintained while maintaining an existing driving force. Accordingly, there is no sense of awkwardness when worn, and in particular, the cooling rate is improved to realize fast responsiveness. On the other hand, the new manufacturing method and configuration according to the present embodiment may be applied to the number of springs constituting the fabric, such as in the wire diameter, from several to several hundred.

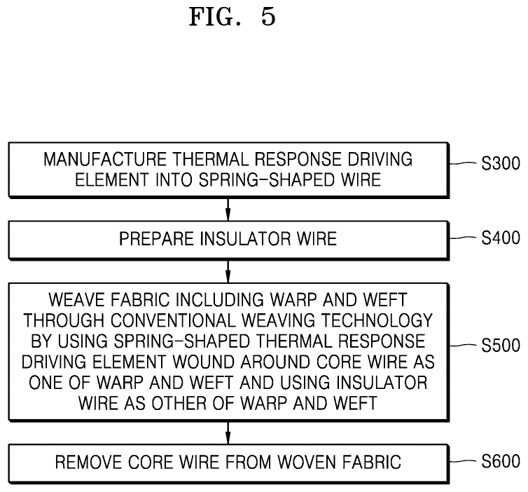

FIG. 5 illustrates an example of a flowchart for the process of manufacturing the SMA spring fabric 11 in FIG. 4.

A method of manufacturing a fabric, according to the present embodiment, may weave a fabric including warp and weft by using a spring-shaped thermal response driving element (SMA spring) yarn as one of the warp and the weft and using a wire (e.g., a general fiber yarn) as the other of the warp and the weft.

For example, the method of manufacturing a fabric, according to the present embodiment, may include manufacturing an SMA wire into a spring-shaped yarn (S300), preparing a wire (S400), and weaving a fabric by using a spring-shaped thermal response driving element yarn and a separate wire (S500).

First, the manufacturing of the SMA wire, which is a thermal response driving element, into the spring-shaped yarn (S300) may include continuously winding the SMA wire around a core wire (a base wire) into a spring/coil shape.

In this regard, as an example, it may include continuously winding the SMA wire around the core wire in a spring shape by using a wire to be removed later as the core wire, and memorizing a spring-shaped thermal response driving wire wound around the core wire in a spring shape through pre-or post-heat treatment.

As an embodiment, a base wire including a metal which has a melting point of 500° C. or higher and is dissolved by reacting with an acid or a hydrogen peroxide solution may be used as the core wire. Accordingly, an additional process may be required to melt and remove the metal core from the woven SMA fabric by acid treatment.

On the other hand, as another example, a wire which has the property of carbonizing at a high temperature may be used as the core wire. In this case, the core wire may include a natural fiber yarn, and the natural fiber yarn may include cotton, hemp, silk, or wool. The core wire may be somewhat memorized as a spring shape by the SMA wire wrapped therearound due to the frictional force of the natural fiber wire itself, even without separate pre-heat treatment. After the SMA fabric is woven with the SMA wire memorized in the spring shape, the SMA fabric undergoes a process of completely memorizing the spring shape through heat treatment at the fabric level, carbonizing the core wire which is the natural fiber, and washing and removing the carbonized core wire. Accordingly, a final SMA fabric for a flexible actuator may be completed through a relatively simple process without a separate acid treatment. In particular, by using the flexible natural fiber yarn as the core wire, it may be easily manufactured by the same process as the existing weaving machine (textile machine), making mass production possible through automation.

The process itself of making an SMA spring, which is one of the yarns constituting the fabric, into a long wire/yarn is not limited to a specific manufacturing method. However, for example, it may be manufactured by a method already filed by the applicant of the present disclosure (e.g., Method of Manufacturing SMA Spring, Korea Patent Application No. 10-2020-0029517), the disclosure of which may be incorporated by reference in its entirety.

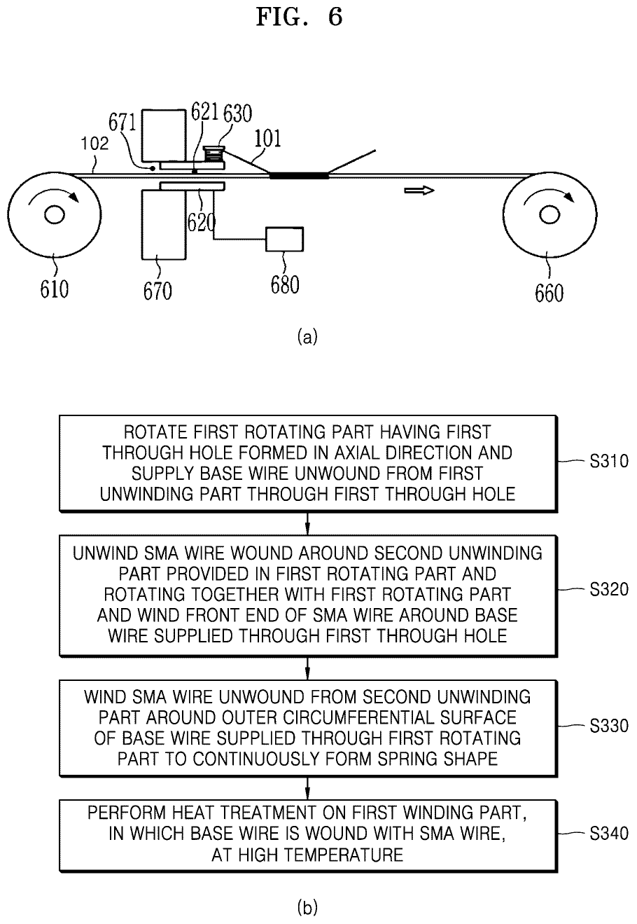

For example, a method of manufacturing an SMA wire into a spring-shaped yarn may include supplying a base wire (a core wire) 102 made of a natural fiber yarn having a carbonization temperature of 300° C. or higher, winding an SMA wire around the supplied base wire, and continuously forming a spring shape in which the SMA wire is wound around the base wire, as illustrated in FIG. 6.

As illustrated in FIG. 6, an apparatus for manufacturing a yarn in an SMA spring shape may include a first unwinding part 610, a first rotating part 620, a second unwinding part 630, and a first winding part 660.

In the first unwinding part 610, a wound base wire/core wire 102 may be unwound. The base wire 102 may have an outer diameter corresponding to an inner diameter of an SMA spring 101 to be manufactured.

As described above, as an example, the base wire 102 may be made of a material which is carbonized by heat treatment of an SMA fabric. As a specific example, the base wire 102 is a natural fiber yarn which is carbonized at about 300° C. or higher, and may include, for example, cotton, hemp, silk, wool, or the like.

The base wire 102 unwound from the first unwinding part 610 may be wound around the first winding part 660. As an optional embodiment, the base wire 102 may be supplied at a constant speed.

The first winding part 660 may include a bobbin made of a material which may withstand the heat treatment temperature of the SMA spring. The bobbin may be provided in the form of a spool or a reel and may be formed to include at least one material among metal, ceramic, silicone, and glass, which are capable of withstanding the temperatures of about 500° C. or higher. Highly corrosion-resistant, high-melting-point metal materials which are capable of withstanding the temperature of about 1,000° C. or higher may be included.

The first rotating part 620 may be provided in the supply direction of the base wire 102 unwound from the first unwinding part 610. For example, the first rotating part 620 may be arranged between the first unwinding part 610 and the first winding part 660.

A first through hole 621 may be formed to pass through the first rotating part 620 toward the center. The base wire 102 may be supplied by passing through the first through hole 621, and the first through hole 621 may have an inner diameter greater than an outer diameter of the base wire 102.

The first rotating part 620 may be rotatably coupled to a first support part 670. The first support part 670 may be provided in the supply direction of the base wire 102 unwound from the first unwinding part 610. For example, the first support part 670 may be arranged between the first unwinding part 610 and the first winding part 660.

A first connection hole 671 may be formed to pass through the first support part 670 in the supply direction of the base wire 102.

The first rotating part 620 may be arranged to be fixed or coupled to the first support part 670. Furthermore, the first rotating part 620 may perform a rotational motion. For example, the first rotating part 620 may perform a rotational motion while being connected or coupled to the first support part 670.

Furthermore, for example, the first through hole 621 may have the same central axis as the first connection hole 671. As a specific example, the first rotating part 620 may be coupled to the first support part 670 and may rotate around the central axis of the first through hole 621.

The second unwinding part 630 may be arranged on the outer circumferential surface of the first rotating part 620. The second unwinding part 630 may be arranged to rotate around a rotation shaft provided in the radial direction of the first rotating part 620. For example, the rotation shaft of the rotational motion of the second unwinding part 630 may be in a direction crossing or perpendicular to the rotation shaft of the rotational motion of the first rotating part 620.

Furthermore, the second unwinding part 630 may rotate together with the first rotating part 620 when the first rotating part 620 rotates, and the second unwinding part 630 itself may also rotate (perform the rotational motion). That is, the second unwinding part 630 may simultaneously perform a first rotation (e.g., a revolution motion) with the central shaft of the first rotating part 620 as the center and a second rotation (e.g., the rotational motion) with the rotation shaft provided in the radial direction of the first rotating part 620 as the center.

In the second unwinding part 630, the SMA wire 101 may be unwound. The SMA wire 101 unwound from the second unwinding part 630 may be wound around the outer circumferential surface of the base wire 102 unwound from the first unwinding part 610 and then supplied through the first through hole 621 of the first rotating part 620. The SMA wire 101 may be a single wire rod. The SMA wire 101 may form a wire rod of the SMA spring, and the diameter of the wire rod of the SMA spring may be the diameter of the SMA wire 101.

The diameter of the wire rod of the SMA spring is not limited, but may be 1.0 mm or less, preferably 0.5 mm or less, and more preferably 0.1 mm or less, which is the thickness of a human hair. In case that the diameter of the SMA wire 101 is the same as described above, the SMA wire 101 may be tied and fixed to the base wire 102. Accordingly, there is an advantage in that a separate fixing device does not need to be used.

As a front end of the SMA wire 101 unwound from the second unwinding part 630 is wound around the base wire 102, the base wire 102 is continuously supplied, and as the first rotating part 620 rotates, the SMA wire 101 may be wound around the outer circumferential surface of the base wire 102 along the longitudinal direction of the base wire 102. As the supply of the base wire 102 continues while the SMA wire 101 is wound around the base wire 102, the second unwinding part 630 may rotate to allow the SMA wire 101 to be continuously unwound.

The base wire 102 with the SMA wire 101 wound therearound may be wound around the first winding part 660.

As illustrated in FIG. 6(B), a method of manufacturing an SMA spring yarn (yarn) may include operation S310 in which the first rotating part 620 having the first through hole 621 formed in an axial direction is rotated and the base wire 102 unwound from the first unwinding part 610 is supplied through the first through hole 621. At this time, as an optional embodiment, the base wire 102 may be supplied at a constant speed, thereby implementing a form in which the SMA wire 101 is wound more uniformly.

In operation S310, the base wire 102 unwound from the first unwinding part 610 may be supplied through the first rotating part 620 and wound around the bobbin of the first winding part 660.

The method of manufacturing an SMA spring yarn may include operation S320 in which the SMA wire 101 wound around the second unwinding part 630 arranged adjacent to or connected to the first rotating part 620 and rotating together with the first rotating part 620 is unwound, and the front end of the SMA wire 101 is wound around the base wire 102 supplied through the first through hole 621.

In operation S320, the SMA wire 101 may include a nickel-titanium alloy or a copper-titanium alloy, which has an advantage of being able to control the deformation temperature in a wide range, having a large deformation amount, and having a shape memory effect ability which hardly changes even after many repeated motions during shrinkage, but the present disclosure is not limited thereto, and the SMA wire 101 may include a copper-zinc alloy, a gold-cadmium alloy, or an indium-thallium alloy.

Furthermore, the method of manufacturing an SMA spring yarn (yarn) may include operation S330 in which the SMA wire 101 unwound from the second unwinding part 630 is wound around the outer circumferential surface of the base wire 102 supplied through the first rotating part 620 to continuously form a spring shape.

In operation S330, the rotation speed and the rotation time of the first rotating part 620 may be controlled by the control part, and accordingly, the pitch and the length of the spring may be controlled.

As a result of operations S320 and S330, the SMA spring implemented with the SMA wire 101 may be formed on the base wire 102. The SMA wire 101 may be in a state of being wound around the base wire 102 wound around the bobbin of the first winding part 660.

The base wire 102 around which the SMA wire 101 is wound may be obtained in the form of a yarn (see FIG. 4 illustrating an example diagram of the SMA spring yarn manufactured by FIG. 6), and this may be used as the warp or the weft for weaving the SMA spring fabric.

That is, the base wire, which is the core wire, is required for weaving, and a final fabric is completed by carbonizing and removing the base wire through heat treatment after the base wire is woven into a fabric.

Next, as illustrated in FIG. 5, the SMA spring yarn wound around the core wire and the yarn (heat-resistant yarn) which withstands a high temperature of 300° C. or higher (e.g., Kevlar yarn, glass fiber yarn, or arimid yarn) are used to weave SMA fabric (cloth) including warp/weft by an existing weaving technology, such as a loom or a weaving machine (S500). Because the existing weaving technology, such as a loom or a spinning machine, is obvious to those of ordinary skill in the art, a detailed description thereof is omitted.

Next, the woven SMA fabric is fixed to a fixing jig. The SMA fabric fixed to the fixed jig is heat-treated at a high temperature of, for example, 300° C. or higher so that the SMA spring yarn constituting the fabric is memorized in a coil/spring shape.

Through the heat treatment on the jig, the SMA spring yarn may be memorized in a coil/spring shape, and the natural fiber yarn, which is the core wire existing as the center of the SMA spring yarn, may be carbonized.

Finally, the SMA fabric which is heat-treated while being fixed to the fixed jig is washed to remove the carbonized core wire (natural fiber yarn) (S600).

After these processes, only the SMA spring yarn from which the core wire is removed and the SMA fabric in which the general yarn includes the warp and the weft finally remain, as illustrated in FIG. 4.

This allows the SMA fabric to stretch and shrink in a direction in which the SMA spring yarn is woven.

It will be understood that the micro-diameter SMA spring fabric 11 manufactured as described above may be used by appropriately cutting the fabric size according to the required driving force, etc., or may be installed as a plurality of fabrics.

The cloth muscle 10 according to the embodiment of FIG. 2 may include an SMA spring fabric 11 including a plurality of micro-diameter SMA wires and arranged to be changeable between a contracted state and a relaxed state according to a temperature change, and an electrode 12 arranged in a region of the SMA spring fabric 11 so as to supply an electric current. For example, at least two electrodes 12 may be arranged on the SMA spring fabric 11 while being spaced apart from each other. As a specific example, two electrodes 12 may be respectively arranged on a side of the SMA spring fabric 11 and another side spaced apart therefrom. The cloth muscle 10 may further include a relaxation length limiting part 14 configured to limit the relaxation length of the SMA spring fabric 11.

The relaxation length limiting part 14 may be arranged on at least one side of the SMA spring fabric 11. For example, two relaxation length limiting parts 14 may be arranged on both sides of the SMA spring fabric 11. In other words, the SMA spring fabric 11 may be arranged between the two relaxation length limiting parts 14.

As an optional embodiment, as illustrated in FIGS. 2 and 3, the elongated wire-shaped relaxation length limiting part 14 may be arranged on one side or both sides of the SMA spring fabric 11.

As an alternative to the wire as the relaxation length limiting part 14, an outer sheath (see FIG. 4) may be optionally arranged to wrap the SMA spring fabric 11 inside. That is, in the present embodiment, because the plurality of SMA springs are fixed in a fabric form, an outer sheath for the function of maintaining individual springs as in the past may not necessarily be required.

As an optional embodiment, in case that the relaxation length limiting part 14 has an outer sheath shape, the outer sheath may perform at least the function of limiting the relaxation length of the SMA spring fabric 11, and the outer sheath may be made of various materials. For example, it may be preferable that the outer sheath is made of a mesh material that allows smooth airflow for cooling the SMA within the SMA spring fabric 11. In FIGS. 2 and 3, the SMA spring fabric itself is illustrated as the element of the module, but the outer sheath with the fabric embedded thereinto may also be the element of the module.

### Wearable part

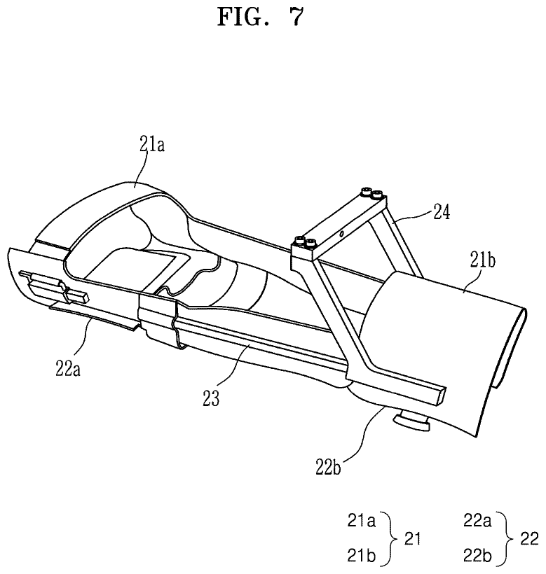

The wearable part 20 of the knee muscular strength-assisting suit 1 where the cloth muscle 10, which is the driving part, is attachable to or detachable from is described with reference to FIGS. 7 to 10. The wearable part 20 in the present disclosure may include a part which is coupled to the driving part 10 to constitute the skeleton or frame of the entire suit worn by a user.

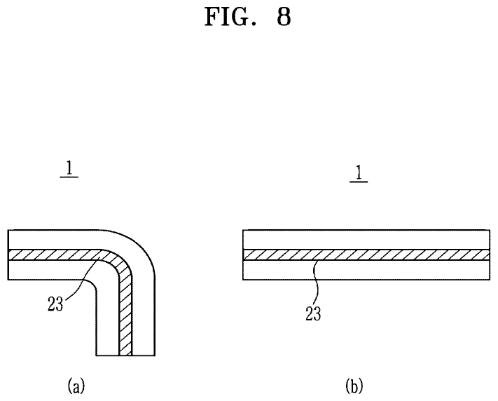

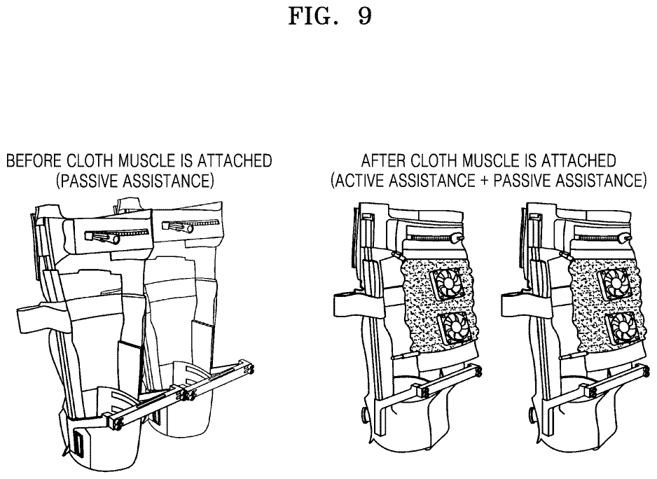

FIG. 7 is an example configuration diagram of the wearable part 20 used in the knee muscular strength-assisting suit 1, and FIG. 8 illustrates an action of an elastic bar 23, which is an element of the wearable part 20. FIG. 9 illustrates active assistance and passive assistance as a knee muscular strength-assisting method according to an embodiment of the present disclosure. FIG. 10 is a control configuration diagram of the knee muscular strength-assisting suit 1 according to an embodiment of the present disclosure.

The wearable part 20 is detachably coupled to the driving part and mounted on the wearer so that a first driving force may be transmitted to the wearer's knee, and generates a second driving force which may be transferred to the wearer's knee when used. FIG. 7 illustrates a state before the driving part, which is the cloth muscle, is attached.

The wearable part 20 may include a driving part fixture 21, a fastener 22, and an elastic bar 23.

The driving part fixture 21 may be configured to be separable from and connectable to the driving part, and may include an upper fixture 21a and a lower fixture 21b.

The upper fixture 21a may be formed to fix the upper end of the cloth muscle with a zipper, Velcro, etc. In particular, as described above, the cloth muscle in the present embodiment is made of fabric, and thus, it is very easy to form a zipper part on the fabric itself. In this case, it may be efficient for the driving part fixture 21 to be directly or indirectly coupled to the upper end of the cloth muscle by a zipper. The lower fixture 21b may be arranged to adjust the length so that the cloth muscle is pulled to apply appropriate tension and the lower end thereof is fixed with Velcro. The Velcro configuration may be replaced with other fasteners such as a zipper.

The fastener 22 may be installed near opposite ends of the wearable part 20 in the longitudinal direction with respect to the knee to fix the knee muscular strength-assisting suit 1 to the user, and may include a thigh fastener 22a at the upper end and a calf fastener 22b at the lower end.

The thigh fastener 22a and the calf fastener 22b may be configured to fasten the knee muscular strength-assisting suit 1 to the thigh area and the calf area, respectively, and a fastening means such as Velcro or Boa may be used.

The elastic bar 23 may be made of an elastic material and one or more elastic bars 23 may be installed in the longitudinal direction of the knee muscular strength-assisting suit 1. The elastic bar 23 may be formed to perform the following functions.

First, because the elastic bar 23 has a material and shape which do not deform in the longitudinal direction, the distance between the thigh fastener 22a and the calf fastener 22b may be controlled or maintained constant.

The distance between support points may be controlled or maintained through the elastic bar 23. As a specific example, the distance between support points may be maintained at a constant level through the elastic bar 23. The driving force may be efficiently concentrated on a desired area, compared to a case where the elastic bar 23 is not provided. Furthermore, the elastic bar 23 may reduce or prevent a phenomenon that the driving force is not concentrated on a specific area and is dispersed because in case that the driving force is applied, the fastener (i.e., the support point) is not completely fixed and is moved in a direction in which the driving force is generated. Furthermore, because the elastic bar 23 in the present embodiment maintains/fixes the distance between the thigh fastener 22a and the calf fastener 22b at a constant level, the driving force from the cloth muscle may be concentrated on a specific area without being wasted. Consequently, the elastic bar 23 may solve a problem that the distance between the thigh fastener 22a and the calf fastener 22b may be reduced due to the wearer's motion or the contractile force of the cloth muscle, and thus, the contractile motion of the cloth muscle may be weakened.

Second, the elastic bar 23 may generate a driving force to assist the extension motion of the knee due to the elastic material. As described above, the elastic bar 23 does not deform in the longitudinal direction so as to maintain a constant distance between the thigh fastener and the calf fastener, but the elastic bar 23 is elastic in the bending direction of the knee joint, and thus, the knee joint may bend freely. This may also be confirmed in FIG. 8. That is, the driving force by the elastic bar 23 may be said to be a passive driving force that is distinct from an active driving force generated by the cloth muscle. Accordingly, even before the cloth muscle 10 is attached to the wearable part 20, the knee extension motion may be assisted with only the elastic bar 23 (the passive assistance). After the cloth muscle 10 is attached to the wearable part 20, the active assistance as well as the passive assistance of the elastic bar 10 may be added by a contractile force when electricity is applied to the cloth muscle (a combination of the active assistance and the passive assistance).

The wearable part 20 may optionally include an amplifier 24 configured to increase the driving force generated from the cloth muscle 10.

The amplifier 24 is configured to perform amplification so that the force of the cloth muscle fixed to the thigh is converted into a large rotation force to rotate the calf. This may act as a patella which converts a contractile force of a quadriceps femoris muscle in the human body into a large rotation force. As illustrated in FIGS. 7 to 9, the amplifier 24 may be formed to protrude to amplify the rotation force. For example, the amplifier 24 may include a slot which protrudes in a direction crossing a longitudinal direction of an elastic part 10 (for example, in a perpendicular direction) and maintains a certain position so that a band passes therethrough.

As an optional embodiment, a bag may include a controller and a battery and may be worn on the user's waist, etc. For example, the controller and the battery may be fixedly installed within the bag, and the bag may be configured to store and carry the cloth muscle and/or the fasteners. Such a bag configuration may increase the portability and ease of use of the knee muscular strength-assisting suit wearer.

The controller may include an intention recognition part configured to determine a motion intention of the wearer and a control part configured to generate a driving control signal to the driving part in response to a signal from the intention recognition part. This is described below.

As described above, the knee muscular strength-assisting method according to an embodiment may basically include a passive muscular strength assistance operation by the elastic force of the elastic bar 23 of the wearable part 20 which may be transferred to the wearer's knee, and may optionally include an active muscular strength assistance operation by the driving force of the cloth muscle 10 which may be transferred to the wearer's knee. That is, before the cloth muscle 10 is attached to the wearable part 20, only the passive muscular strength assistance may be performed, and after the cloth muscle 10 is attached to the wearable part 20, the active muscular strength assistance may be performed together with the passive muscular strength assistance.

According to the knee muscular strength-assisting method according to the present embodiment, the wearing may be facilitated with only the thigh and calf fasteners, and the knee extension muscular strength assistance (the passive assistance) may be provided by the elastic bar even without attaching the cloth muscle. Furthermore, the knee muscular strength-assisting suit of the present embodiment may be worn like everyday clothes without attaching the cloth muscle at normal times, and in case that additional muscular strength assistance is needed, the cloth muscle may be attached to enable both active assistance and passive assistance.

FIG. 10 is a control-related configuration diagram of the knee muscular strength-assisting suit 1 according to an embodiment of the present disclosure.

The knee muscular strength-assisting suit 1 according to an embodiment of the present disclosure may include a control part 300 configured to control power supply for changing an operation between a contracted state and a relaxed state of a cloth muscle 10, an electricity supply part 310, an intention recognition/detection part 320, and a battery/power source part 330.

The control part 300 may control whether to supply electricity to the thermal response driving element 101 so that the operation of the SMA spring fabric 11 may change from a contracted state to a relaxed state, or vice versa.

As a specific example, the control part 300 may control whether to supply electricity to the SMA spring fabric 11 through the electricity supply part 310. In case that the control part 300 transmits an electricity supply signal to the electricity supply part 310, the electricity supply part 310 may supply an electric current to the SMA spring fabric 11. Furthermore, in case that the control part 300 transmits an electricity supply stop signal to the electricity supply part 310, the electricity supply part 310 may stop supplying an electric current so that the electric current no longer flows to the thermal response driving element 100.

By controlling whether to supply electricity as described above, in case that the electric current is supplied to the SMA spring fabric 11, heat is generated and the SMA spring fabric 11 contracts, and in case that the supply of the electric current is stopped, the temperature decreases and the SMA spring fabric 11 relaxes.

The electricity supply part 310 is an electric current driver connected to the cloth muscle 10 and configured to supply an electric current to the cloth muscle 10. The electric current driver may be of one of various shapes or types and may include, for example, one or more driving integrated circuits (ICs). However, because the electric current driver may be used by selecting one of various examples, a detailed description thereof is omitted.

The detection part 320 may include a sensor configured to detect a wearer's biometric information or motion. Here, the biometric information may include electromyogram. For example, in case that the detection part 320 includes an electromyography sensor, the sensor may detect the movement or motion (specifically, a contraction motion or a relaxation motion) of the wearer's muscles according to the gripping, moving, and supporting of heavy goods. As another example, the detection part 320 may include a voice sensor 320a. In this case, the sensor may be formed to receive the wearer's current actions, status, needs, etc. through the wearer's voice information.

Furthermore, the detection part 320 may include a sensor configured to detect deformation of the cloth muscle 10. For example, the detection part 320 may include a strain gauge. The detection part 320 may include a sensor configured to detect the temperature of the cloth muscle 10, which may be usefully used in a massage apparatus which performs a fan operation according to temperature by repeating relaxation and contraction motions.

The power source part 330 may be configured to supply electricity to at least one of the control part 300, the electricity supply part 310, and the detection part 320.

The control part 300 may control an electric current supplied to a heating response driving element of the electricity supply part 310 based on information detected by the detection part 320.

For example, in case that the wearer performs a motion which requires contraction of the thermal response driving element, such as a motion of straightening the knee, the detection part 320 may transmit the measured electromyography information to the control part 300, and the control part 300 may determine that the wearer intends to perform the motion of straightening the knee, based on the electromyography information. Furthermore, the control part 300 may calculate a force required for the wearer to straighten the knee and derive a target force to be output from the cloth muscle 10. To implement this, the control part 300 may control an electric current supplied from the electricity supply part 310 to the thermal response driving element so that the calculated target force is output.

On the other hand, the control part of the cloth muscle according to the present embodiment may control the electricity supply part so that, when the cloth muscle 10 is changed to a relaxed state, the supply of the power to the cloth muscle 10 is cut off and the power is supplied to a cooling part. With this configuration, the supply of the power to the cloth muscle 10 is cut off, the temperature begins to decrease, and the cloth muscle 10 begins to relax. In addition, the relaxation speed of the cloth muscle 10 may increase as the power is supplied to the cooling part, a cooling air supply device such as a fan is operated, and the temperature decrease of the SMA spring fabric 11 is accelerated. Depending on the operating environment of the cloth muscle, the cooling air supply may always be maintained in an on state. To this end, one or more cooling parts (e.g., fans) may be connected to or arranged adjacent to a region of the ankle muscular strength-assisting wearable robot 1, for example, the cloth muscle 10.

### Suit Control Program

The device described above and the control therefor may be implemented as a hardware component, a software component, and/or a combination of a hardware component and a software component. For example, the devices and components described in the embodiments may be implemented by using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing instructions and responding to instructions. A processing device may execute an operating system (OS) and one or more software applications running on the OS. In addition, the processing device may access, store, manipulate, process, and generate data in response to the execution of the software. For ease of understanding, the processing device is sometimes described as being used alone, but it may be understood by those of ordinary skill in the art that the processing device includes a plurality of processing elements and/or a plurality of types of processing elements. For example, the processing device may include a plurality of processors or one processor and one controller. In addition, other processing configurations, such as parallel processors, are also possible.

The software may include a computer program, code, instructions, or a combination of one or more thereof, and may configure a processing device to operate as desired or may instruct the processing device independently or collectively. The software and/or data may be permanently or temporarily embodied in any type of machine, component, physical device, virtual device, computer storage medium, or device so as to be interpreted by the processing device or to provide instructions or data to the processing device. The software may be distributed in network-connected computer systems and stored or executed in a distributed manner. The software and data may be stored on one or more computer-readable recording media.

The method according to an embodiment may be implemented in the form of program instructions that are executable through a variety of computer means and may be recorded on a computer-readable medium. The computer-readable medium may include program instructions, data files, data structures, or the like alone or in combination. The program instructions recorded on the medium may be specially designed and configured for the embodiment or may be known and available to those of ordinary skill in the art of computer software. Examples of the computer-readable recording medium may include magnetic media, such as hard disk, floppy disk, and magnetic tape, optical media, such as compact disc read-only memory (CD-ROM) and digital versatile disc (DVD), magneto-optical media, such as floptical disk, and hardware devices specially configured to store and execute program commands, such as read-only memory (ROM), random access memory (RAM), and flash memory. Examples of the program commands may include not only machine language code generated by a compiler but also high-level language code that is executable using an interpreter by a computer. The hardware devices described above may be configured to operate as one or more software modules so as to perform the operations of the embodiment, and vice versa.

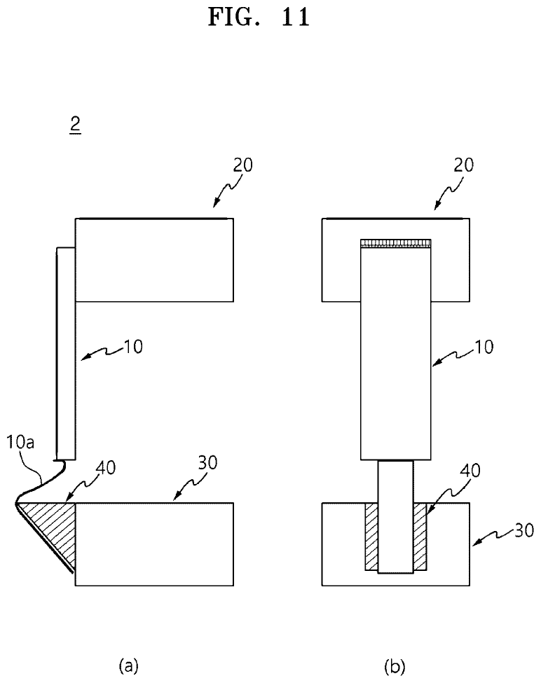

FIG. 11 illustrates a knee muscular strength-assisting suit according to another embodiment of the present disclosure. For example, a knee muscular strength-assisting suit 2 of the present embodiment may be a knee muscular strength-assisting suit having a patellar structure, and FIG. 11 may illustrate a side view and a front view, respectively, of the knee muscular strength-assisting suit having the patellar structure.

As illustrated in FIG. 11, the knee muscular strength-assisting suit 2 of the present embodiment may largely include a driving part 10 which generates a driving force for knee muscular strength assistance, an upper fastening part 20 which is detachably coupled to the driving part 10 and configured to be worn on the upper end of the wearer's knee, and a lower fastening part 30 which is detachably coupled to the lower end of the driving part 10 through a force transfer band and configured to be worn on the lower end of the wearer's knee.

Furthermore, the knee muscular strength-assisting suit 2 according to an embodiment of the present disclosure may include a patellar structure to amplify a rotation force. To this end, the lower fastening part 30 may include a structure which is detachable from and attachable to an amplification part 40 formed to convert a force generated from the driving part into a large rotation force.

Hereinafter, each of the driving part 10, the upper and lower fastening parts 20 and 30, and the amplification part 40 of the patellar structure is described in detail.

### Driving Part (Cloth Muscle)

The cloth muscle 10 according to the present embodiment may be formed so that the cloth muscle itself contracts and relaxes by causing the control part 300 to contract and relax the fabric-shaped thermal response driving element in which the spring-shaped SMA is woven. Furthermore, the control part may be provided separately from the driving part, and in some cases, may be arranged adjacent to or integral with a region of the driving part or the wearable part. On the other hand, the cloth muscle 10 may be modified and applied as needed within a range substantially the same as or similar to that described with reference to FIGS. 2 to 4 in the above-described embodiment, and therefore, a more detailed description thereof is omitted for convenience of explanation.

Moreover, the cloth muscle according to the present embodiment may be manufactured through the same process as a general weaving machine (textile machine), may be mass-produced through automation, and may be provided to the user in the fabric form. In case that the cloth muscle may be provided in the fabric form, the user may use the cloth muscle by directly cutting the cloth muscle into a desired shape, size, etc. Accordingly, the freedom of design may also be improved.

For example, hundreds of SMA springs may be assembled to form the SMA spring fabric (11 of FIG. 2 in the above-described embodiment), which is a single module. By using the fabric based on the micro-diameter SMA wire, the flexibility of the cloth is significantly maintained while maintaining an existing driving force. Accordingly, there is no sense of awkwardness when worn, and in particular, the cooling rate is improved to realize fast responsiveness. On the other hand, the new manufacturing method and configuration according to the present embodiment may be applied to the number of springs constituting the fabric, such as in the wire diameter, from several to several hundred.

Furthermore, substantially the same description as the example flowchart for the process of manufacturing the SMA spring fabric 11 and the apparatus for manufacturing the SMA spring-shaped yarn, which have been described with reference to FIGS. 5 and 6 in the above-described embodiment, may be applied to the present embodiment, and therefore, a more detailed description hereof is omitted for convenience of explanation. Furthermore, the cloth muscle 10 of the knee muscular strength-assisting suit 2 of the present embodiment may include an SMA spring fabric (see 11 of FIG. 2 in the above-described embodiment) arranged to be changeable between a contracted state and a relaxed state according to a temperature change and including a plurality of micro-diameter SMA wires, and electrodes (12 of FIG. 2 in the above-described embodiment) formed on a side and another side of the SMA spring fabric (see 11 of FIG. 2 in the above-described embodiment) for supplying an electric current.

Furthermore, the cloth muscle 10 of the knee muscular strength-assisting suit 2 of the present embodiment may further include a relaxation length limiting part (14 of FIG. 2 in the above-described embodiment) configured to limit the relaxation length of the SMA spring fabric (see 11 of FIG. 2 in the above-described embodiment). The relaxation length limiting part may be substantially the same as the relaxation length limiting part 14 described with reference to FIGS. 2 and 4 in the above-described embodiment. For example, the relaxation length limiting part may be provided in a wire form on one side or both sides of the SMA spring fabric. As another example, the relaxation length limiting part may optionally include an outer sheath to wrap the SMA spring fabric inside. In this case, the outer sheath may be made of various materials (e.g., a mesh material which allows smooth airflow for cooling). Because specific details are the same as those described in the above-described embodiment, further description thereof is omitted.

In relation to the structure of the module-type cloth muscle, a zipper which may be coupled to the muscular strength-assisting suit may be attached to the upper end of the cloth muscle. Zippers may be attached to both the upper end and the lower end of the cloth muscle. As described above, the cloth muscle itself is made of fabric, and thus, a zipper may be easily attached thereto. On the other hand, a force transfer band may be additionally attached to the lower end of the cloth muscle so as to transfer the contractile force of the cloth muscle. By attaching zippers to both the upper end and the lower end of the cloth muscle, the force transfer bands may be connected to each other with the zippers.

### Fastening Part

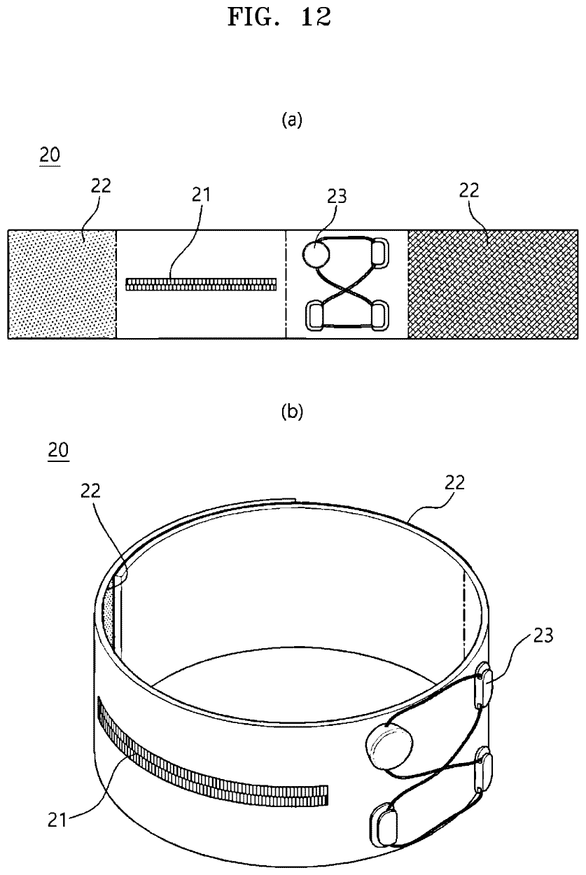

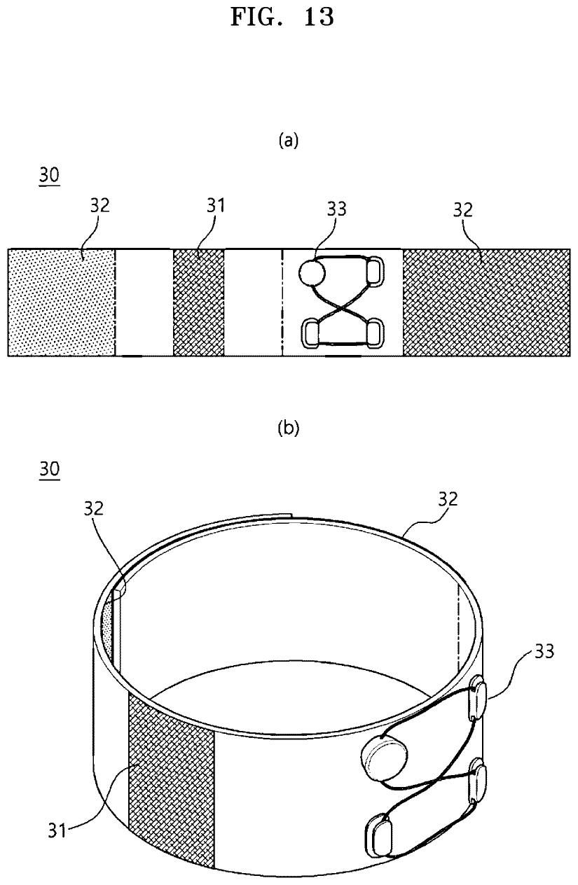

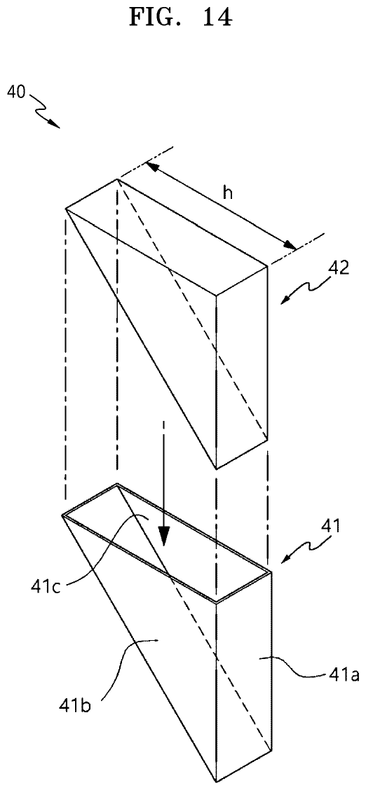

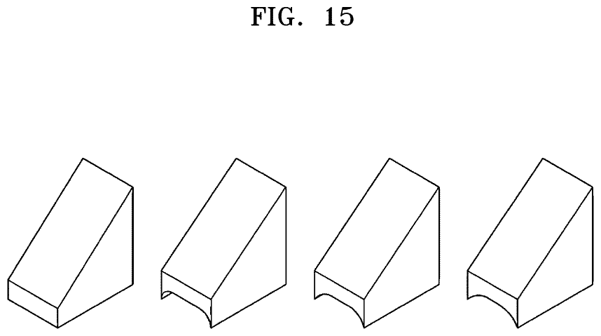

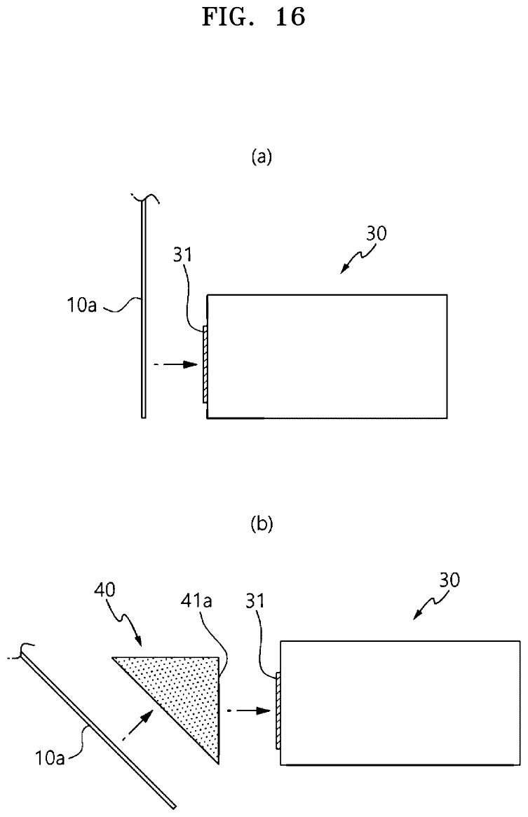

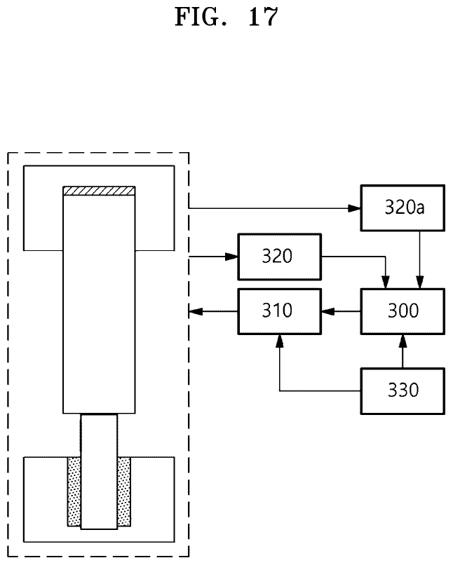

The upper and lower fastening parts 20 and 30 of the knee muscular strength-assisting suit 2 where the cloth muscle 10, which is the driving part described above, is detachable from and attached to are described with reference to FIGS. 12 to 17. FIG. 12 is an example configuration diagram of an upper fastening part of FIG. 11, and FIG. 13 is an example configuration diagram of a lower fastening part of FIG. 11. FIG. 13 is an example configuration diagram of the lower fastening part of FIG. 11. FIG. 14 is an example configuration diagram of an amplification part of FIG. 11. FIG. 15 is an example configuration diagram of an insert of FIG. 14. FIG. 16 illustrates (a) an unused state and (b) a used state of the amplification part as a knee muscular strength-assisting method using the knee muscular strength-assisting suit of FIG. 11. FIG. 17 schematically illustrates a control-related concept of the knee muscular strength-assisting suit of FIG. 11.

The upper and lower fastening parts 20 and 30 may be a structure which is (directly or indirectly) detachably connected to the driving part 10, which is the cloth muscle, and fastened to a wearer so that the driving force may be transferred the wearer's knee.

The fastening part illustrated in FIG. 12 is an upper fastening part 20 which is fastened at a position higher than the knee, such as the thigh, and may be formed as a flexible strap in the form of cloth. It is preferable that the strap has a vertical width sufficient to allow sufficient frictional force to be applied. On the other hand, the terms “upper” and “lower” may be understood as relative positions with respect to the knee, for example, the thigh area and the calf area, respectively.

The upper fastening part 20 may include a driving part fixture 21, Velcro 22, and Boa 23, as confirmed from FIG. 12.

The driving part fixture 21 may be formed to fix the upper end of the cloth muscle with a zipper, Velcro, etc. In particular, as described above, the cloth muscle in the present embodiment is made of fabric, and thus, it is very easy to form a zipper part in the fabric itself. Accordingly, the upper fastening part 20 and the upper end of the cloth muscle may be zipper-coupled to each other.

As an optional embodiment, the Velcro 22 may be formed at opposite ends of the strap and arranged to be coupled to each other, so as to form a cylindrical structure when fastened to the thigh area.

Additionally, the Boa 23 may be arranged as a structure to further strengthen the fastening structure.

The fastening part illustrated in FIG. 13 is a lower fastening part 30 which is fastened at a position below the knee, such as the calf, and like the upper fastening part, may be formed as a flexible strap in the form of cloth.

The lower fastening part 30 includes a driving part fixing part 31, Velcro 32, and Boa 33, as confirmed from FIG. 13.

The driving part fixing part 31 may be formed to fix the lower end of the cloth muscle or a force transfer band 10a connected to the lower end of the cloth muscle by using Velcro or the like. In particular, the driving part fixing part 31 formed in the lower fastening part 30 may be formed to be attached to the force transfer band or a pocket part of an amplification part described below, depending on the wearer's choice. That is, as illustrated in FIGS. 14 and 16, at normal times, the force transfer band 10a is used by being coupled to the driving part fixing part 31 of the lower fastening part 30 with Velcro (see (a) of FIG. 16), but in a situation where a large rotation force is required, the pocket part 41 may be coupled to the driving part fixing part 31 with Velcro and the force transfer band 10a may be coupled to a force transfer band attachment surface 41b of the pocket part 41 with Velcro (see (b) of FIG. 16).

As an optional embodiment, the Velcro 32 may be formed at opposite ends of the strap and arranged to be coupled to each other, so as to form a cylindrical structure when fastened to the calf area.

Additionally, the Boa 33 may be arranged as a structure to further strengthen the fastening structure.

### Patellar Structure—Amplification Part

As described above, the lower fastening part 30 may be optionally detachable from and attached to the amplification part 40 configured to increase the driving force generated from the cloth muscle 10 (see FIG. 16).

The amplification part 40 is configured so that the force of the cloth muscle fixed to the thigh may be converted into a large rotation force to rotate the calf. This acts as a patella which converts a contractile force of a quadriceps femoris muscle in the human body into a large rotation force. For example, as illustrated in FIGS. 14 to 16, the amplification part 40 may protrude in one direction to amplify the rotation force. For example, the amplification part 40 may protrude in a direction away from the lower fastening part 30. As a specific example, the amplification part 40 may be formed to protrude perpendicularly to the lower fastening part 30.

The amplification part 40 may include a pocket part 41 formed to be detachably attached to the lower fastening part 30 (in particular, the driving part fixing part 31) with Velcro, and a block-shaped insert 42 configured to be inserted/embedded into the pocket part 41.

As illustrated in FIG. 14, the pocket part 41 includes a calf attachment surface 41a which is a surface directly attached to the lower fastening part 30, a force transfer band attachment surface 41b which is a surface to which the force transfer band 10a is attached, and an insert insertion surface 41c.

Here, the force transfer band attachment surface 41b may correspond to the inclined surface of an approximately triangular patellar structure. The lower fastening part 30 and the calf attachment surface 41a are coupled to each other with Velcro. In this case, for stable operation when the driving force is applied, the force transfer band 10a and the force transfer band attachment surface 41b may be coupled with Velcro over the entire inclined surface. That is, the force transfer band 10a connected to the lower end of the cloth muscle may be fixed to the lower inclined surface 41b of the patellar structure with Velcro.

The insert insertion surface 41c may include a separate cover to maintain the insert insertion state even when the driving force is applied.

By adopting the pocket-type structure in the present embodiment, a pocket frame is maintained and only the insert is changed and inserted, enabling easy and quick response for each wearer or each usage situation.

The insert 42 is preferably made of a flexible material which is well in close contact with the calf area when the driving force is applied and, in this case, provides a comfortable feeling to the wearer. The insert 42 may be made of, for example, lightweight and high-rigidity Styrofoam or plastic.

It is preferable that the insert 42 has substantially the same shape as the pocket part 41 so as to be seated inside the pocket part 41.

Furthermore, as an optional embodiment, the surface of the insert corresponding to the calf attachment surface 41a of the pocket part 41 is formed to be concave inward. This is illustrated in FIG. 15. The inner concave surface may be well in close contact with the wearer's calf area when the driving force is applied, and may provide a comfortable feeling to the wearer.

The degree of amplification into the rotation force may be determined by the height of the insert 42 inserted into the pocket part 41, and the height of the insert 42 may correspond to the degree of protrusion of the insert 42 when mounted. That is, as a moment arm height (‘h’ in FIG. 14) of the patellar structure increases, the force of the cloth muscle 10 is greatly amplified into the rotation force.

The insert 42 inserted into the pocket part 41 may be selected from a plurality of inserts, and the plurality of inserts may be prepared so that the height and/or the length of the calf attachment surface are different from each other. That is, as a result, it is possible to freely attach and detach patellar structures with different heights of the moment arm, different lengths of the calf attachment surface, etc., as needed.

### Others

The upper fastening part 20 and the lower fastening part 30 may be connected to each other through one or more elastic bars. The elastic bar is configured to perform the following functions.

First, because the elastic bar is made of a material and shape which do not deform in the longitudinal direction, the distance between the upper fastening part 20 and the lower fastening part 30 may be controlled or maintained constant. The distance between support points may be controlled or maintained through the elastic bar. As a specific example, the distance between support points may be maintained at a constant level through the elastic bar. The driving force may be efficiently concentrated on a desired area, compared to a case where the elastic bar is not provided.

Furthermore, the elastic bar 23 may reduce or prevent a phenomenon that the driving force is not concentrated on a specific area and is dispersed because in case that the driving force is applied, the fastener (i.e., the support point) is not completely fixed and is moved in a direction in which the driving force is generated. Because the elastic bar in the present embodiment maintains/fixes the distance between the upper fastening part 20 and the lower fastening part 30 at a constant level, the driving force from the cloth muscle may be concentrated on a specific area without being wasted. Consequently, the elastic bar may solve a problem that the distance between the upper fastening part 20 and the lower fastening part 30 may be reduced due to the wearer's motion or the contractile force of the cloth muscle, and thus, the contractile motion of the cloth muscle may be weakened.

Second, the elastic bar may generate a driving force to assist the extension motion of the knee due to the elastic material. As described above, the elastic bar does not deform in the longitudinal direction so as to maintain a constant distance between the upper fastening part and the lower fastening part, but the elastic bar is elastic in the bending direction of the knee joint, and thus, the knee joint may bend freely. That is, the driving force by the elastic bar may be said to be a passive driving force that is distinct from an active driving force generated by the cloth muscle. Accordingly, even before the cloth muscle 10 is attached to the upper and lower fastening parts 20 and 30, the knee extension motion may be assisted with only the elastic bar (the passive assistance). After the cloth muscle 10 is attached to the upper and lower fastening parts 20 and 30, the active assistance as well as the passive assistance of the elastic bar may be added by a contractile force when electricity is applied to the cloth muscle (a combination of the active assistance and the passive assistance).

A bag may include a controller and a battery and may be worn on the user's waist, etc. For example, the controller and the battery may be fixedly installed within the bag, and the bag may be configured to store and carry the cloth muscle and/or the fasteners. Such a bag configuration may increase the portability and ease of use of the knee muscular strength-assisting suit wearer.

The controller may include an intention recognition part configured to determine a motion intention of the wearer and a control part configured to generate a driving control signal to the driving part in response to a signal from the intention recognition part. This is described below.

As described above, the knee muscular strength-assisting method according to an embodiment includes wearing the upper fastening part and the lower fastening part at the upper end and the lower end of the knee, respectively, directly or indirectly coupling the cloth muscle configured to generate the driving force to the upper fastening part and the lower fastening part, respectively, and, in case that the driving force is to be converted into a large rotation force, using the amplification part by attaching the amplification part to the lower fastening part. Of course, the order of the operations in performing the method may vary. That is, some or all of the components of the suit may be first coupled, and the combined structure may be then worn.

As described above, the insert to be inserted into the pocket part may be selected from the plurality of inserts having different heights and/or different lengths of the calf attachment surface depending on the intended use.

### Suit Control and Related-Control Program

FIG. 17 is a control-related configuration diagram of the knee muscular strength-assisting suit 2 according to an embodiment of the present disclosure.

The knee muscular strength-assisting suit 2 according to an embodiment of the present disclosure may include a control part 300 configured to control power supply for changing an operation between a contracted state and a relaxed state of a cloth muscle 10, an electricity supply part 310, an intention recognition/detection part 320, and a battery/power source part 330.

The control part 300 may control whether to supply electricity to the thermal response driving element 101 so that the operation of the SMA spring fabric 11 may change from a contracted state to a relaxed state, or vice versa. As a specific example, the control part 300 may control whether to supply electricity to the SMA spring fabric 11 through the electricity supply part 310. In case that the control part 300 transmits an electricity supply signal to the electricity supply part 310, the electricity supply part 310 may supply an electric current to the SMA spring fabric 11. Furthermore, in case that the control part 300 transmits an electricity supply stop signal to the electricity supply part 310, the electricity supply part 310 may stop supplying an electric current so that the electric current no longer flows to the thermal response driving element 100.

By controlling whether to supply electricity as described above, in case that the electric current is supplied to the SMA spring fabric (for example, see 11 of FIG. 2 in the above-described embodiment), heat is generated and the SMA spring fabric contracts, and in case that the supply of the electric current is stopped, the temperature decreases and the SMA spring fabric relaxes.

The electricity supply part 310 is an electric current driver connected to the cloth muscle 10 and configured to supply an electric current to the cloth muscle 10. The electric current driver may be of one of various shapes or types and may include, for example, one or more driving integrated circuits (ICs). However, because the electric current driver may be used by selecting one of various examples, a detailed description thereof is omitted. The detection part 320 may include a sensor configured to detect a wearer's biometric information or motion. Here, the biometric information may include electromyogram. For example, in case that the detection part 320 includes an electromyography sensor, the sensor may detect the movement or motion (specifically, a contraction motion or a relaxation motion) of the wearer's muscles according to the gripping, moving, and supporting of heavy goods. As another example, the detection part 320 may include a voice sensor 320a. In this case, the sensor may be configured to receive the wearer's current actions, status, needs, etc. through the wearer's voice information.

Furthermore, the detection part 320 may include a sensor configured to detect deformation of the cloth muscle 10. For example, the detection part 320 may include a strain gauge. The detection part 320 may include a sensor configured to detect the temperature of the cloth muscle 10, which may be usefully used in a massage apparatus which performs a fan operation according to temperature by repeating relaxation and contraction motions.

The power source part 330 may be configured to supply electricity to at least one of the control part 300, the electricity supply part 310, and the detection part 320.

The control part 300 may control an electric current supplied to a heating response driving element of the electricity supply part 310 based on information detected by the detection part 320.

For example, in case that the wearer performs a motion which requires contraction of the thermal response driving element, such as a motion of straightening the knee, the detection part 320 may transmit the measured electromyography information to the control part 300, and the control part 300 may determine that the wearer intends to perform the motion of straightening the knee, based on the electromyography information. Furthermore, the control part 300 may calculate a force required for the wearer to straighten the knee and derive a target force to be output from the cloth muscle 10. To implement this, the control part 300 may control an electric current supplied from the electricity supply part 310 to the thermal response driving element so that the calculated target force is output.

On the other hand, the control part of the cloth muscle according to the present embodiment may control the electricity supply part so that, when the cloth muscle 10 is changed to a relaxed state, the supply of the power to the cloth muscle 10 is cut off and the power is supplied to a cooling part. With this configuration, the supply of the power to the cloth muscle 10 is cut off, the temperature begins to decrease, and the cloth muscle 10 begins to relax. In addition, the relaxation speed of the cloth muscle 10 may increase as the power is supplied to the cooling part, a cooling air supply device such as a fan is operated, and the temperature decrease of the SMA spring fabric 11 is accelerated. Depending on the operating environment of the cloth muscle, the cooling air supply may always be maintained in an on state. To this end, one or more cooling parts (e.g., fans) may be connected to or arranged adjacent to a region of the ankle muscular strength-assisting wearable robot 1, for example, the cloth muscle 10.

The device described above and the control therefor may be implemented as a hardware component, a software component, and/or a combination of a hardware component and a software component. For example, the devices and components described in the embodiments may be implemented by using one or more general-purpose computers or special-purpose computers, such as a processor, a controller, an ALU, a digital signal processor, a microcomputer, an FPGA, a PLU, a microprocessor, or any other device capable of executing instructions and responding to instructions. A processing device may execute an OS and one or more software applications running on the OS. In addition, the processing device may access, store, manipulate, process, and generate data in response to the execution of the software. For ease of understanding, the processing device is sometimes described as being used alone, but it may be understood by those of ordinary skill in the art that the processing device includes a plurality of processing elements and/or a plurality of types of processing elements. For example, the processing device may include a plurality of processors or one processor and one controller. In addition, other processing configurations, such as parallel processors, are also possible.

The software may include a computer program, code, instructions, or a combination of one or more thereof, and may configure a processing device to operate as desired or may instruct the processing device independently or collectively. The software and/or data may be permanently or temporarily embodied in any type of machine, component, physical device, virtual device, computer storage medium, or device so as to be interpreted by the processing device or to provide instructions or data to the processing device. The software may be distributed in network-connected computer systems and stored or executed in a distributed manner. The software and data may be stored on one or more computer-readable recording media.

The method according to an embodiment may be implemented in the form of program instructions that are executable through a variety of computer means and may be recorded on a computer-readable medium. The computer-readable medium may include program instructions, data files, data structures, or the like alone or in combination. The program instructions recorded on the medium may be specially designed and configured for the embodiment or may be known and available to those of ordinary skill in the art of computer software. Examples of the computer-readable recording medium may include magnetic media, such as hard disk, floppy disk, and magnetic tape, optical media, such as CD-ROM and DVD, magneto-optical media, such as floptical disk, and hardware devices specially configured to store and execute program commands, such as ROM, RAM, and flash memory. Examples of the program commands may include not only machine language code generated by a compiler but also high-level language code that is executable using an interpreter by a computer. The hardware devices described above may be configured to operate as one or more software modules so as to perform the operations of the embodiment, and vice versa.

As described above, although the embodiments have been described with reference to the restrictive embodiments and drawings, various modifications and variations may be made thereto from the description by those of ordinary skill in the art. For example, appropriate results may be achieved even when the technologies described above are performed in an order different from the methods described above, and/or components of the system, structure, device, and circuit described above are coupled or combined in a different form from the methods described above or are replaced or substituted by other components or equivalents.

Therefore, other implementations, other embodiments, and equivalents to the claims also fall within the scope of the claims described below.

As described above, although the embodiments have been described with reference to the restrictive embodiments and drawings, various modifications and variations may be made thereto from the description by those of ordinary skill in the art. For example, appropriate results may be achieved even when the technologies described above are performed in an order different from the methods described above, and/or components of the system, structure, device, and circuit described above are coupled or combined in a different form from the methods described above or are replaced or substituted by other components or equivalents.

Therefore, other implementations, other embodiments, and equivalents to the claims also fall within the scope of the claims described below.

1. A knee muscular strength-assisting suit comprising:
a driving part arranged to generate a first driving force for knee muscular strength assistance; and
a wearable part detachably coupled to the driving part and configured to transfer the first driving force to a wearer's knee and generate a second driving force capable of being transferred to the wearer's knee when used.

2. The knee muscular strength-assisting suit of claim 1, wherein the first driving force is an active driving force, and the second driving force is a passive driving force.

3. The knee muscular strength-assisting suit of claim 1, wherein the driving part comprises a cloth muscle configured to contract or relax by power supplied from an outside.

4. The knee muscular strength-assisting suit of claim 3, wherein the cloth muscle comprises a woven fabric of warp and weft.

5. The knee muscular strength-assisting suit of claim 4, wherein the woven fabric comprises:
a spring-shaped thermal response driving element corresponding to one of the warp and the weft; and
a heat-resistant wire configured to function as one of the warp and the weft.

6. The knee muscular strength-assisting suit of claim 1, wherein the wearable part comprises:
a driving part fixture configured to be coupled to the driving part; and
a fastener installed at opposite ends of the wearable part in a longitudinal direction and configured to fix the knee muscular strength-assisting suit to the wearer.

7. The knee muscular strength-assisting suit of claim 6, wherein the wearable part comprises an elastic bar installed along the longitudinal direction of the wearable part and configured to generate the second driving force when used.

8. The knee muscular strength-assisting suit of claim 6, wherein the driving part and the driving part fixture are connected to each other by a zipper.

9. The knee muscular strength-assisting suit of claim 6, wherein the fastener comprises a thigh fastener and a calf fastener, and the fastener is length-adjustable.

10. The knee muscular strength-assisting suit of claim 7, wherein the elastic bar does not deform in the longitudinal direction so as to maintain a constant distance between the fasteners, and is elastic in a bending direction of a knee joint so that the knee joint bends freely.

11. The knee muscular strength-assisting suit of claim 1, wherein the wearable part further comprises an amplifier configured to increase the first driving force.

12. A knee muscular strength-assisting method comprising:
a passive muscular strength assistance operation by an elastic force of a wearable part which is capable of being transferred to a wearer's knee; and
an active muscular strength assistance operation by a driving force of a cloth muscle which is capable of being transferred to the wearer's knee,
wherein before the cloth muscle is attached to the wearable part, only the passive muscular strength assistance is performed, and after the cloth muscle is attached to the wearable part, the active muscular strength assistance is performed together with the passive muscular strength assistance.

13. The knee muscular strength-assisting method of claim 12, wherein the elastic force of the wearable part is generated by an elastic bar installed along a longitudinal direction of the wearable part.

14. The knee muscular strength-assisting method of claim 13, wherein the elastic bar is configured to perform a passive muscular strength-assisting function and a position fixing function of a thigh-calf fastener for maintaining a contractile motion of the cloth muscle.

15. The knee muscular strength-assisting method of claim 12, further comprising a driving force amplification operation configured to increase the driving force of the cloth muscle.

16. A knee muscular strength-assisting suit formed to perform the knee muscular strength-assisting method of claim 12.

17. A knee muscular strength-assisting suit comprising:
a driving part arranged to generate a driving force for knee muscular strength assistance;
an upper fastening part detachably coupled to an upper end of the driving part and arranged to be worn on an upper end of a wearer's knee; and
a lower fastening part detachably coupled to a lower end of the driving part through a force transfer band and arranged to be worn on a lower end of the wearer's knee,
wherein the lower fastening part includes a structure which is detachable from and attachable to an amplification part formed to convert a force generated from the driving part into a large rotation force.

18. The knee muscular strength-assisting suit of claim 17, wherein the amplification part comprises:
a pocket part formed to be detachable from and attachable to the lower fastening part; and
an insert of a flexible material formed to be inserted into the pocket part.

19. The knee muscular strength-assisting suit of claim 18, wherein the insert has substantially a same shape as the pocket part.

20. The knee muscular strength-assisting suit of claim 18, wherein the pocket part comprises a calf attachment surface corresponding to a surface attached to the lower fastening part, a force transfer band attachment surface corresponding to a surface to which the force transfer band is attached, and an insert insertion surface for embedding the insert, and the force transfer band attachment surface corresponds to an inclined surface of a patellar structure.
